(19) United States
(12) Patent Application Publication
(10) Pub. No.: US 2012/0298136 A1
(43) Pub. Date: Nov. 29, 2012

(54) DEVICE AND METHOD FOR PROCESSING A GROUND SURFACE OF ARTIFICIAL TURF

(75) Inventor: Cornelis Hermanus Maria De Bree, Driebergen (NL)

(73) Assignee: REDEXIM HANDEL-EN EXPLOITATIE MAATSCHAPPIJ B.V., Zeist (NL)

(21) Appl. No.: 13/517,235

(22) PCT Filed: Dec. 17, 2010
(86) PCT No.: PCT/NL2010/050861

§ 371 Date: Jul. 13, 2012

(30) Foreign Application Priority Data
Dec. 21, 2009 (NL) 2003994

(51) Int. Cl. B08B 1/00

(52) U.S. Cl. 134/6; 15/21.1

(57) ABSTRACT

Device for processing a ground surface of artificial turf comprising filler, the device comprising a frame (11) and moving means arranged for moving the device over the ground surface in a working direction, a supplier arranged for taking up a flow of material from the ground surface, such as dirt and filler, and for supplying the flow to a processing device (3) arranged for processing the flow of material, wherein the supplier extends at a distance above the ground surface and that the device further comprises an engaging device (41) arranged for engaging the material on the ground surface for loosening said material.

The present invention relates a device for processing, for instance cleaning, a ground surface of artificial turf comprising filler, the device comprising a frame and moving means arranged for moving the device over the ground surface in a working direction, a supplier arranged for taking up a flow of material from the ground surface, such as dirt and filler, and for supplying the flow to a processing device arranged for processing the flow of material. The invention further relates to a method for processing a ground surface of artificial turf comprising filler.

Artificial turf is widely used in for instance sports fields and comprises a base layer provided with a plurality of fibres. Filler material is provided between these fibres to prevent excess bending of the fibres.

Devices for processing or cleaning the filler of a ground surface of artificial turf are known. Such devices are provided with supply means in the form of a rotating brush provided with relatively stiff tufts for taking up material, for instance the dirt and filler, from said ground surface. The tufts engage the ground surface and thereby take up a flow of material. The flow of material is then supplied to a processing device, for instance a device for cleaning the filler in the flow of material.

However, the engaging brush, in particular the tufts thereof, has a high impact on the ground surface and may therefore result in processing wear of the artificial turf.

It is therefore goal of the present invention, amongst other goals, to provide a device for processing a ground surface of artificial turf which has little impact on said surface, thereby decreasing the processing wear.

The above goal is met by the present invention, amongst other goals, by a device as defined in the appended claim 1.

Specifically, in order to meet the above goal, amongst other goals, the device according to the preamble is characterized in that the supplier extends at a distance above the ground surface and that the device further comprises an engaging device arranged for engaging the material on the ground surface for loosening said material. Since the supplier does not contact the surface, wear of the ground surface is minimized during the processing of said ground surface. In order to allow an efficient take-up of material, the material is loosened by the engaging means before take-up. The engaging means are arranged to mechanically engage the material, thereby for instance breaking of patches or pads of material. Since the engaging device is only arranged to loosen, for instance breaking up large chunks of material, the impact on the ground surface is limited.

The moving means may comprise any suitable means for moving the device and may include wheels and/or a sledge. The device is preferably providing with a motor for driving the moving means.

The supplier or supply means may for instance comprise a suction unit for taking up material by creating a low-pressure region above ground level. The device is hereto preferably providing with a pump for sucking up said material. The supplier may also comprise a rotating brush for moving the sucked in material to the processing device. It should however be noted that it is also possible to use the engaging device according to the invention in a device provided with a supplier which does engage the ground surface, for instance in the form of a conventional rotating brush.

The processing device or means may for instance comprise a separator to separate the filler material from dirt. The filler material may then be returned to the ground surface using a suitable outlet, while the dirt is stored in a container. It may also be possible that the processing device is arranged as a container. The device may then be arranged to take out the filler material from a ground surface of artificial turf.

Preferably the engaging device is arranged in front of the supplier seen in the working direction. The material is then first loosened and due to the movement of the device, the material is taken up by the supplier. Since the engaging device only needs to loose up the material, and does not need to transport the material, the material and thereby the ground surface can be engaged with lower impact than when using a conventional supplier in the form of a rotating brush. The processing wear of the ground surface is thus minimized.

More preferably the engaging device is arranged to engage the material on the ground surface with a speed substantially equal to or smaller than a working speed of the device moving in the working direction. The relative speed between the ground surface and the engaging device engaging said ground surface is hereby equal to or smaller than the working speed of the device. Preferably the relative speed is smaller than the working speed. This decreases the impact of the engaging device on the ground surface. The direction of the relative movement may vary.

According to a preferred embodiment the engaging device is arranged to engage the material on the ground surface with a predetermined working depth, wherein the working depth is preferably approximately 5 mm above the base layer of the artificial turf. This further minimized the processing wear of the surface, while still ensuring a good loosening up action of the engaging device. The engaging device is hereby preferably arranged to always keep a distance of at least 5 mm to the base layer of the artificial turf.

A further preferred embodiment of the device further comprises a sensor for sensing the ground surface, wherein the engaging device is arranged to adapt a working depth in dependency of a sensed property of said ground surface. The sensor may be arranged to detect height differences in the ground surface and adapt the working depth in accordance therewith. It may also be possible that the sensor detects a visual or mechanical property of the material, for instance the consistency, thickness or size of patches of material. The sensor may hereto be a visual sensor and/or a mechanical sensor. The sensor may for instance comprise a ground following device, preferably in the form of a moving means of the device. A wheel of the device may for instance be arranged to detect height differences in the ground surface.

According to a further preferred embodiment the engaging device is arranged to engage the material on the ground surface along at least the width of a working width of the supplier. The working width preferably extends perpendicular to the direction of movement of the device over the ground surface. This ensures that all material for take up is efficiently loosened up.

According to a preferred embodiment of the device according to the invention the engaging device comprises at least one engaging member arranged for engaging the material on the ground surface, wherein the engaging member is manufactured from a resilient material. The resiliency of the material ensures in a good contact between the ground surface and the engaging member and may compensate for height differences in the ground surface. Preferably the engaging device comprises a plurality of engaging members. This increases the loosening capacity of the engaging device.

More preferably the engaging members comprise elongate engaging members, wherein a first end of the elongate members is arranged for engaging the material and wherein a second end is held to the frame. The plurality of first ends of the engaging members hereby provides an efficient loosening of the material. The second ends are preferably connected to the engaging device, wherein the engaging device is connected to the frame. The relative height of the frame and the engaging device may then be adjusted to adjust the working depth of the elongate engaging members. Even more preferably the elongate member comprises a strip or tuft manufactured from metal, plastic or a combination thereof.

It is further advantageously when at least the first end of the elongate member is biased towards the ground surface, wherein the length of the elongate member is preferably adjustable. The engaging force of the engaging members on the ground surface is hereby adjustable. The engagement can then be adjusted to the type of ground surface being processed. Preferably the first ends exert an engaging force on the ground surface having a horizontal component. The first ends of the elongate members hereby extend in a direction having a horizontal component. The second ends may hereby extend substantially vertically.

According to a further preferred embodiment of the device according to the invention, the engaging device comprises a rotating member, wherein the rotating member is provided a plurality of engaging members. The engaging members hereby engage the ground surface due to the rotating movement of the rotating member. The rotating member preferably comprises a cylindrically shaped body, wherein the engaging members extend radially from the cylindrical body.

Preferably the engaging members are finger shaped, wherein a first end of the engaging members are arranged to engage the material on the ground surface and wherein a second end of the engaging members are connected to the rotating member. The fingers hereby ‘massage’ the material, loosening said material. More preferably the fingers are provided with a rounded end, thereby further decreasing the processing wear. Preferably the engaging members are manufactured from a plastic or rubber, preferably vulcanized rubber. More preferably the engaging members have a stiffness substantially equal or smaller than the stiffness of the fibres of the artificial turf. Wear of these fibres provided on the base layer is hereby minimized.

According to a further preferred embodiment the rotating member is arranged to rotate a direction such that the engaging members move in the same direction as the ground surface. The relative speed between the engaging members and the ground surface is hereby decreased. It is even possible that the rotating speed is substantially equal to the moving speed of the device. The engaging members hereby move along the ground surface with a substantially equal speed.

The device is preferably provided with a suitable motor for driving or rotating the rotating member. This allows a steady and reliable loosening action. The device is preferably provided with a transmission connecting the motor and the rotating member for rotating the rotating member.

Preferably the motor is arranged to rotate the rotating member for moving the engaging members, in particular the ends thereof, over the ground surface with a speed different from the working speed. The engaging members hereby engage the ground surface with a relative speed different from zero with respect to the ground surface. This further increases the loosening action. Preferably the difference in speed is at least 2% of the working speed, more preferably at least 5% and most preferably at least 10% of the working speed.

According to a further preferred embodiment of the device according to the invention, the processing device comprises at least one nozzle for spraying a liquid on at least a part of the flow of material. The supplied flow of material can thus be cleaned, for instance prior to returning the filler material from said flow of material to the ground surface. The nozzle is preferably arranged to apply a mist of liquid.

The liquid may hereby comprise a disinfecting agent, hereby disinfecting the ground surface during processing.

The invention furthermore relates to a method for processing a ground surface of artificial turf comprising filler, the method comprising the step of engaging material on the ground surface, such as dirt and filler, for loosing said material, taking up a flow of loosened material and processing said flow of material.

The present invention is further illustrated by the following Figures, which show a preferred embodiment of the device according to the invention, and are not intended to limit the scope of the invention in any way, wherein:

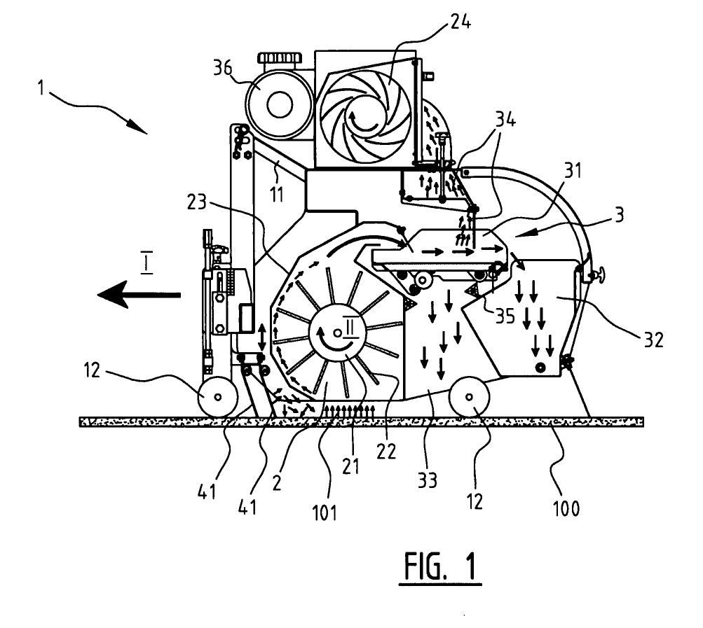

FIG. 1 schematically shows a first embodiment of the cleaning device according to the invention;

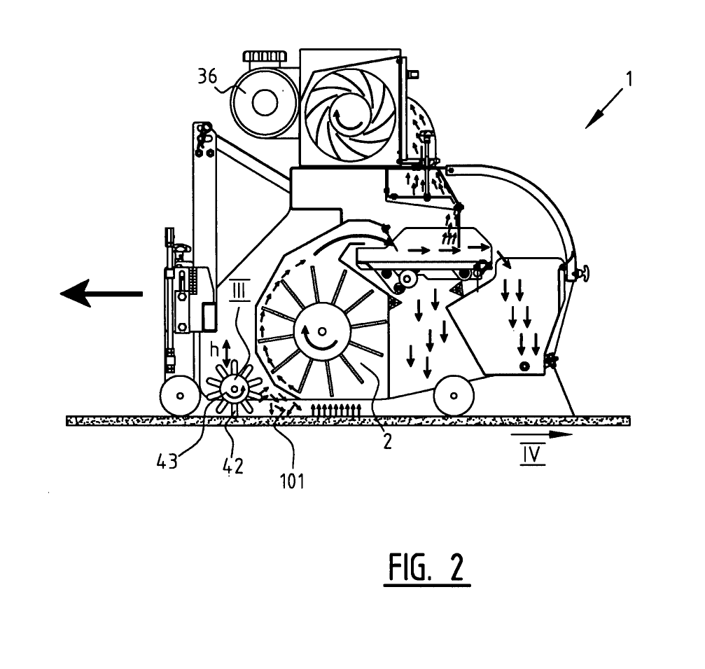

FIG. 2 schematically shows a second embodiment of the cleaning device according to the invention, and;

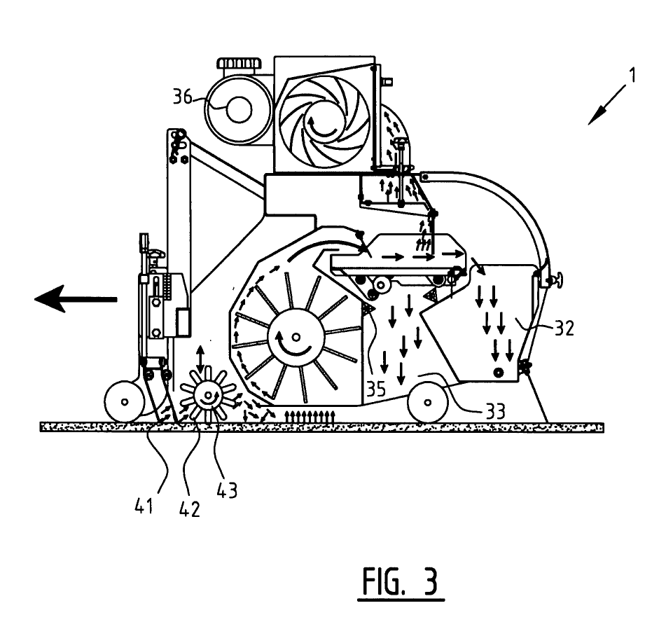

FIG. 3 schematically shows an embodiment which is a combination of embodiments 1 and 2.

In FIG. 1 a device 1 for cleaning a ground surface 100 of artificial turf comprising filler according to the invention is shown. The device 1 comprises a frame 11 and wheels 12 for allowing movement of the device in a working direction indicated with I. The device 1 is a self propelling device and is therefore provided with a suitable engine (not shown).

To take up a flow of material in the form of filler and dirt for cleaning, the device 1 is provided with a rotating brush 21 and a pump 24. The pump is arranged to apply an under pressure around the rotating brush 21 to allow taking up of material 101 from the ground surface. The brush is provided with a plurality of tufts 22 to guide the material from the ground surface 100 to the processing means 3 along casing 23, as indicated with the arrows. The brush 21 hereby rotates in a direction indicated with II. Since the actual taking up of material is achieved by the sucking action of the pump 24, taking up of material is thus achieved without contacting the surface with the tufts 22 of brush 21. Wear of the ground surface 100 is thus minimized.

The processing device 3 is arranged in the form of a sieve 31. The filler material is allowed to pass through the sieve 31 and is returned to the ground surface through an outlet 33, while the larger debris is collected in bin 32.

Provided near the sieve 31 is a suction unit 34 connected with the pump 24. Dust resulting from the sieving process is sucked in using said suction unit 34. Further, nozzles 35 are provided near the outlet 33. Nozzles 35 spray a mist of disinfecting fluid on the passing filler material. The fluid is held in a tank 36 provided on the frame 11 of the device. The filler or infill material returned through outlet 33 is thus cleaned.

In order to improve the supply of material from the surface 100 by the pump 24 and the brush 21, an engaging device in the form of metal strips 41 is provided in front of the brush 21. The metal strips 41 are provided along the whole working width of the device 1. The metal strips 41 are resilient and are biased towards the ground surface 100. The strips 41 thereby apply a force on the material of the ground surface 100, thereby loosing the material. Patches of dirt on the ground surface are thus broken apart and can be easily sucked in the device 1. However, due to the resilient properties of the strips 41, wear of the surface of the artificial turf is minimized.

An elongate member in the form of strip 41 is connected to the frame using two connection points holding the strip at two different locations seen in the longitudinal direction of the strips. To be able to change the working depth of the strips 41, the height of the connection points or the holding locations on the strips can be adjusted along a height h. To change the resilient properties of the strips 41, it is further possible to change the distance between the two connection points of the strip 41.

An alternative to the engaging device in the form of strips 41 is shown in FIG. 2. In this embodiment, a rotating body 43 is provided. The circumferential surface of the cylindrical body 43 is provided with a plurality of rubber fingers 42. The ends of the fingers 42 are arranged to engage the material on the ground surface for loosening said material. The position of the body 43 with respect to the frame 11 can hereby be adapted along a height h to adjust the working depth of the fingers 42. The height h of the engaging devices can be adjusted based on information provided by an optical sensor (not shown).

The body 43 rotates in a direction indicated with III with a speed substantially equal to the moving speed of the device 1. The fingers 42 engaging the surface 100 thereby move in the same direction IV and with substantially the same speed as the ground surface 100. The processing wear of the ground surface is thus minimized, while still providing in a good loosening action.

However, in another embodiment, the body 43 is rotated in a direction III with a speed lower than the working speed of the device 1. Upon engaging the ground surface, the fingers 42 move over said ground surface.

FIG. 3 shows a device 1 provided with both strips 43 and the rotating body 43 with fingers 42.

The present invention is not limited to the embodiment shown, but extends also to other embodiments falling within the scope of the appended claims.

1. A device for processing a ground surface of artificial turf comprising:
a frame and moving means for moving the device over the ground surface in a working direction,
a supplier configured for taking up a flow of material from the ground surface and for supplying the flow to a processing component arranged for processing the flow of material, and
an engaging component configured for engaging the material on the ground surface for loosening said material,
wherein the supplier extends at a distance above the ground surface.

2. The device of claim 1, wherein the engaging component is configured in front of the supplier viewed in the working direction .

3. The device of claim 1, wherein the engaging component is configured to engage the material on the ground surface with a speed substantially equal to or smaller than a working speed of the device moving in the working direction.

4. The device of claim 1, wherein the engaging component is configured to engage the material on the ground surface with a predetermined working depth, wherein the working depth is approximately 5 mm above the base layer of the artificial turf.

5. The device of claim 1, further comprising a sensor for sensing the ground surface, wherein the engaging component is configured to obtain a working depth relating to a sensed property of said ground surface.

6. The device of claim 1, wherein the engaging component is configured to engage the material on the ground surface along at least the width of a working width of the supplier.

7. The device of claim 1, wherein the engaging component comprises at least one engaging member configured for engaging the material on the ground surface, wherein the engaging member is manufactured from a resilient material.

8. The device of claim 1, wherein the engaging component comprises a plurality of engaging members.

9. The device of claim 8, wherein the engaging members comprise elongate engaging members, wherein a first end of the elongate members is configured for engaging the material and wherein a second end is held to the frame.

10. The device of claim 9, wherein the elongate member comprises a strip or tuft, wherein said strip or tuft is manufactured from metal, plastic or a combination thereof.

11. The device of claim 9, wherein at least the first end of the elongate member is biased towards the ground surface, wherein the length of the elongate member is adjustable.

12. The device of claim 1, wherein the engaging component comprises a rotating member, wherein the rotating member includes a plurality of engaging members.

13. The device of claim 12, wherein the engaging members are finger shaped, wherein a first end of the engaging members is arranged to engage the material on the ground surface and wherein a second end of the engaging members are connected to the rotating member.

14. The device of claim 12, wherein the engaging members is manufactured from a plastic or vulcanized rubber.

15. The device of claim 12, wherein the rotating member is arranged to rotate a direction such that the engaging members move in the same direction as the ground surface.

16. The device of claim 12, wherein the device further comprises a motor for driving the rotating member.

17. The device of claim 16, wherein the motor is configured to rotate the rotating member for moving the engaging members over the ground surface with a speed different from the working speed.

18. The device of claim 1, wherein the processing component comprises at least one nozzle for spraying a liquid on at least a part of the flow of material.

19. A method for processing a ground surface of artificial turf comprising filler, the method comprising:
moving a device over the ground surface in a working direction;
engaging a material on the ground surface with a component of the device;
taking up a flow of the material from the ground surface with a supplier, which extends at a distance above the ground;
supplying the flow from the supplier to a processor; and
processing said flow of material with the processor.

20. The method claim 19, wherein the engaging component engages the material on the ground surface with a speed substantially equal to or smaller than a working speed of the device moving in the working direction.

21. The method claim 19, wherein the engaging component engages the material on the ground surface with a predetermined working depth, wherein the working depth is approximately 5 mm above a base layer of the artificial turf.

22. The method claim 19, further comprising sensing the ground surface, wherein the engaging component obtains a working depth relating to a sensed property of said ground surface.
